(19) United States
(12) Patent Application Publication
(10) Pub. No.: US 2015/0186216 A1
(43) Pub. Date: Jul. 2, 2015

(54) METHOD AND APPARATUS FOR SELECTING PROTECTION PATH ON ODU SMP (OPTICAL CHANNEL DATA UNIT SHARED MESH PROTECTION) NETWORK

(71) Applicant: Electronics and Telecommunications Research Institute, Daejeon (KR)

(72) Inventor: Jong Seok LEE, Daejeon (KR)

(21) Appl. No.: 14/578,926

(22) Filed: Dec. 22, 2014

(30) Foreign Application Priority Data
Dec. 27, 2013 (KR) 10-2013-0165304
Aug. 28, 2014 (KR) 10-2014-0113476

(51) Int. Cl. G06F 11/14; G06F 11/07; H04L 12/24; G06F 11/20

(52) U.S. Cl. CPC G06F 11/1423; G06F 11/2012; G06F 11/0793; H04L 41/0654

(57) ABSTRACT

Provided herein is a method and apparatus for selecting a protection path in an ODU SMP (optical channel data unit shared mesh protection) network, the method including in response to a shared resource managed by an intermediate node being preoccupied by a certain protection path, searching by the intermediate node for an identifier relevant to the shared resource; determining by the intermediate node whether or not the searched identifier is registered; in response to determining that the identifier is registered, searching by the intermediate node for a port corresponding to the identifier; and in response to the port being registered, transmitting by the intermediate node a shared resource availability message to a node corresponding to the port.

### CROSS-REFERENCE TO RELATED APPLICATIONS

The present application claims priority to Korean patent application numbers 10-2013-0165304, filed on Dec. 27, 2013 and 10-2014-0113476, filed on Aug. 28, 2014, the entire disclosure of which is incorporated herein in its entirety by reference.

### BACKGROUND

1. Field of Invention

Various embodiments of the present invention relate to a network, and more particularly to a method and apparatus for selecting a protection path in an ODU SMP network.

2. Description of Related Art

In order to support an ODU SMP (optical channel data unit shared mesh protection), a topology of an OTN (optical transport network) must be configured in a mesh form. For this purpose, each node must be connected to a remote node by two or more links, and each link must be connected to a different adjacent node. This condition need not be satisfied in the entirety of a network. A mesh transmission network may be configured even if the aforementioned condition is partially satisfied.

In a complete mesh network arrangement, all nodes existing in the network may be directly connected one-by-one. Such a complete mesh network arrangement provides a high level of ability in restoring from an error, but also provides redundancy in a high level of transmission. Most mesh transmission networks consist of partial mesh networks, and thus in order to go to any other node, an intermediate node has to be passed. In general, two major variables (shared resource use rate and protection switch level) are considered when configuring a shared mesh network, wherein these two variables may be inversely proportionate to each other.

An ODU SMP may define a communication regulation and operation regarding a protection switch supporting an optical transmission network at an ODU (end to end path). The ODU SMP is an automatic switch method specified based on a general shared mesh switch method defined by the ITU-T G.smp. The ODU SMP may use precalculated protection paths. Protection paths must be configured beforehand within all nodes participating in an OTN. When an error occurs in a main path, of these plurality of protection paths (m:n, m is protection path, n is main path), a certain protection path is activated and used.

### SUMMARY

A first purpose of various embodiments of the present invention is to provide a method for selecting a protection path in an ODU SMP network.

A second purpose of various embodiments of the present invention is to provide an apparatus for selecting a protection path in an ODU SMP network.

According to an embodiment of the present invention, there is provided a method for selecting a protection path in an ODU SMP (optical channel data unit shared mesh protection) network, the method including in response to a shared resource managed by an intermediate node being preoccupied by a certain protection path, searching by the intermediate node for an identifier relevant to the shared resource; determining by the intermediate node whether or not the searched identifier is registered; in response to determining that the identifier is registered, searching by the intermediate node for a port corresponding to the identifier; and in response to the port being registered, transmitting by the intermediate node a shared resource availability message to a node corresponding to the port. The shared resource may be allocated to a protection path based on a priority determined by applying a default priority, R/S (Request/State) field, and FCFS (First Come First Service), sequentially, the default priority may instruct a priority allocated to each ODUj connection identifier, in response to a priority determined based on the default priority being the same, the R/S field may instruct a command priority for performing an APS (auto protection switch), and in response to a priority determined based on the default priority and the R/S field being the same, the FCFS may be a priority providing preferential service to an ODUj connection that attempted preoccupation first. The method for selecting a protection path in an ODU SMP network may include searching by the node for a shared resource table based on a CID (connection identifier) field identifier included in the shared resource availability message; in response to the CID field identifier existing in the shared resource table, updating by the node CID field information included in the shared resource table; and in response to a resource corresponding to the CID field information being used in another protection path having a lower priority, notifying a neighboring node connected to an ODUj identifier having a lower priority based on the R/S field included in the shared resource availability message of a resource release, and releasing a cross connect. The method for selecting a protection path in an ODU SMP network may further include monitoring by the intermediate node an interface and detecting an error that occurred in a main path; determining by the intermediate node whether or not a protection path is registered in a node that generated the error; in response to determining that a protection path registered, searching for a resource table and determining a priority of the protection path; and performing a path switch based on the priority. The shared resource availability message may include an APS (auto protection switch)/PCC (protection communication channel) field, the APS/PCC field may include an R/S (request/state) field, Req field, Pri field and CID (connection identifier) field, the R/S field may instruct a resource availability notification message, the Req field may instruct a request format preoccupying a certain shared resource (tributary slot), the Pri field may instruct a priority given to a certain ODU connection preoccupying a shared resource, and the CID (connection identifier) may instruct an ODU connection identifier relevant to the preoccupied shared resource.

According to an embodiment of the present invention, there is provided an apparatus for selecting a protection path in an ODU SMP (optical channel data unit shared mesh protection) network, wherein the apparatus for selecting a protection path may be included in the ODU SMP network, and the apparatus for selecting a protection path may be configured to, in response to a shared resource that it manages being preoccupied by a certain protection path, search for an identifier relevant to the shared resource, determine whether or not the searched identifier is registered, and in response to determining that the identifier is registered, search for a port corresponding to the identifier, and in response to the port being registered, transmit a shared resource availability message to a node corresponding to the port. The shared resource may be allocated to a protection path based on a priority determined by applying a default priority R/S (Request/State) field, and FCFS (First Come First Service), sequentially, the default priority may instruct a priority allocated to each ODUj connection identifier, in response to a priority determined based on the default priority being the same, the R/S field may instruct a command priority for performing an APS (auto protection switch), and in response to a priority determined based on the default priority and the R/S field being the same, the FCFS may be a priority providing preferential service to an ODUj connection that attempted preoccupation first. The node may be configured to search for a shared resource table based on a CID (connection identifier) field identifier included in the shared resource availability message, and in response to the CID field identifier existing in the shared resource table, update CID field information included in the shared resource table, and in response to a resource corresponding to the CID field information being used in another protection path having a lower priority, notify a neighboring node connected to an ODUj identifier having a lower priority based on the R/S field included in the shared resource availability message of a resource release, and release a cross connect. The apparatus for selecting a protection path may be configured to monitor an interface and detect an error that occurred in a main path, determine whether or not a protection path is registered in a node that generated the error, and in response to determining that the protection path is registered, search for a resource table and determine a priority of the protection path, and perform a path switch based on the priority. The shared resource availability message may include an APS (auto protection switch)/PCC (protection communication channel) field, the APS/PCC field may include an R/S (request/state) field, Req field, Pri field and CID (connection identifier) field, the WS field may instruct a resource availability notification message, the Req field instruct a request format preoccupying a certain shared resource (tributary slot), the Pri field may instruct a priority given to a certain ODU connection preoccupying a shared resource, and the CID (connection identifier) may instruct an ODU connection identifier relevant to the preoccupied shared resource.

As aforementioned, a method and apparatus for selecting a protection path in an ODU SMP network according to various embodiments of the present invention may notify beforehand availability information on a certain resource shared by a plurality of protection paths to end nodes relevant to the shared resource.

### BRIEF DESCRIPTION OF THE DRAWINGS

The above and other features and advantages of the present invention will become more apparent to those of ordinary skill in the art by describing in detail embodiments with reference to the attached drawings in which:

FIG. 1 is a conceptual view illustrating a method for activating a certain protection path in response to an error occurring in a main path in an ODU SMP network;

FIG. 2 is a conceptual view illustrating resource sharing in an OTN interface and ODU SMP;

FIG. 3 illustrates a method for activating a bilateral ODU path;

FIG. 4 is a conceptual view illustrating failure of an ODU SMP;

FIG. 5 is a conceptual view illustrating an ODU SMP network according to an embodiment of the present invention;

FIG. 6 is a conceptual view illustrating an ODU OH (overhead) according to an embodiment of the present invention;

FIG. 7 is a flowchart illustrating an operation of an intermediate node according to an embodiment of the present invention;

FIG. 8 is a flowchart illustrating a procedure of processing a shared resource availability notification message according to an embodiment of the present invention; and

FIG. 9 is a flowchart illustrating a procedure of selecting a protection path according to an embodiment of the present invention.

### DETAILED DESCRIPTION

Hereinafter, embodiments will be described in greater detail with reference to the accompanying drawings. Embodiments are described herein with reference to cross-sectional illustrations that are schematic illustrations of embodiments (and intermediate structures). As such, variations from the shapes of the illustrations as a result, for example, of manufacturing techniques and/or tolerances, are to be expected. Thus, embodiments should not be construed as limited to the particular shapes of regions illustrated herein but may include deviations in shapes that result, for example, from manufacturing. In the drawings, lengths and sizes of layers and regions may be exaggerated for clarity. Like reference numerals in the drawings denote like elements.

Terms such as ‘first’ and ‘second’ may be used to describe various components, but they should not limit the various components. Those terms are only used for the purpose of differentiating a component from other components. For example, a first component may be referred to as a second component, and a second component may be referred to as a first component and so forth without departing from the spirit and scope of the present invention, Furthermore, ‘and/or’ may include any one of or a combination of the components mentioned.

It is also noted that in this specification, “connected/coupled” refers to one component not only directly coupling another component but also indirectly coupling another component through an intermediate component. On the other hand, “directly connected/directly coupled” refers to one component directly coupling another component without an intermediate component.

Furthermore, a singular form may include a plural from as long as it is not specifically mentioned in a sentence. Furthermore, “include/comprise” or “including/comprising” used in the specification represents that one or more components, steps, operations, and elements exist or are added.

Furthermore, unless defined otherwise, all the terms used in this specification including technical and scientific terms have the same meanings as would be generally understood by those skilled in the related art. The terms defined in generally used dictionaries should be construed as having the same meanings as would be construed in the context of the related art, and unless clearly defined otherwise in this specification, should not be construed as having idealistic or overly formal meanings.

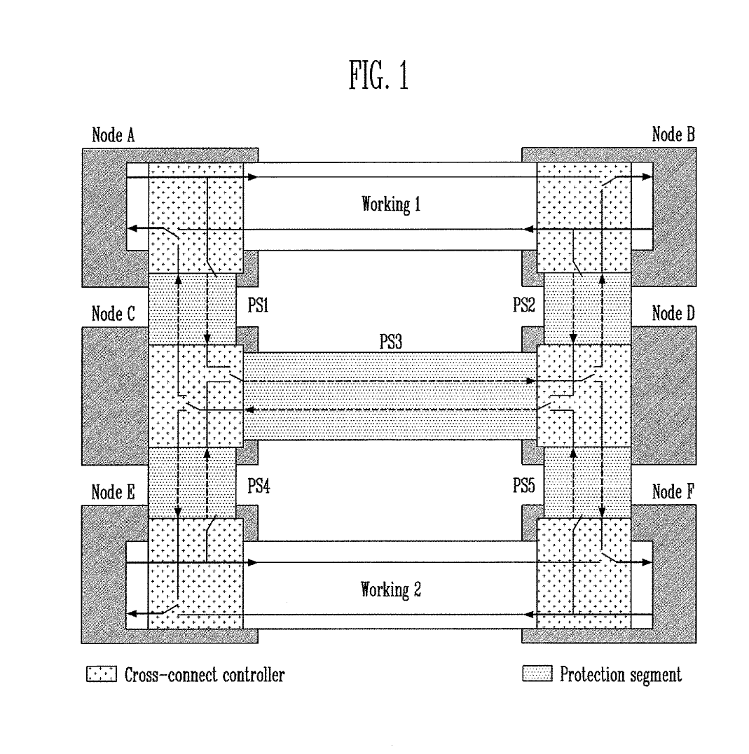

FIG. 1 is a conceptual view illustrating a method for activating a certain protection path in response to an error occurring in a main path of an ODU SMP (optical channel data unit shared mesh protection) network.

Referring to FIG. 1, when a plurality of protections share a certain shared resource in an ODU SMP network, intermediate nodes located in a protection path may not generate a cross connect for allocating the shared resource beforehand for that path. If an error is sensed in a main path, an intermediate node may generate in real time a cross connect for one of the plurality of protection paths in order to protect its traffic signal.

Nodes of both end of the main path may perform supervision of a link status of the main path based on a supervision function. If an error occurs in the main path, a procedure for a protection switch function may be initiated. Intermediate nodes may also notify its resource status information using a supervision and notification function. When its shared resource is preoccupied by another protection connection or an error is sensed in the shared resource, an intermediate node may notify of information on current status of the resource to a head-end node and tail-end node located in a protection path.

A shared resource status of a protection path may not be better than a resource state of a main path. In such a case, end nodes may prevent a user traffic signal from being switched to a protection path where a resource is not available when an error occurs in the main path. A switch type of an ODU SMP may support bilateral switching as defined in the ITU-T G.808.1. In order to support a bilateral ODU SMP, a selector and bridge of the end nodes that participate in a protection path must always operate together, and the operation type must be in an automatic revert mode that reverts to the main path when an error is released as defined in the ITU-T G.808.1.

Since a certain shared resource is used in numerous protection paths, an ODU SMP may distribute resources based on a priority that will be explained hereinafter. First of all, all protection transmission subjects may be provided beforehand with priorities for preoccupation. Secondly, priorities may be given based on the order of request. Priorities may be given based on the order of inducing a protection switching or the order of external commands. Thirdly, priorities may be given to subjects that requested a service first based on the FSFC (First Come First Service) rule.

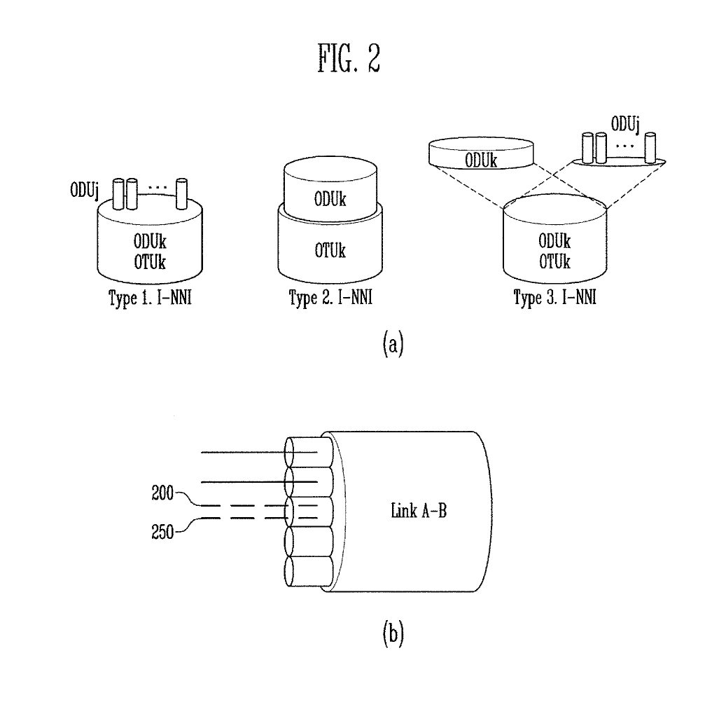

FIG. 2 is a conceptual view an OTN interface and resource sharing in an ODU SMP.

(a) of FIG. 2 illustrates three types of OTN interfaces for smoothly operating an ODU SMP network.

(b) of FIG. 2 illustrates a method for sharing a certain resource in a plurality of ODU connections.

In a general ODU SMP, a plurality of paths may preoccupy resources participating in a protection path through competition to use the resources efficiently.

Referring to (b) of FIG. 2, a certain resource is shared by a RED ODU path 200 and a GREEN ODU path 250 at the same time. A plurality of ODU paths may preoccupy a shared resource according to the aforementioned priority in order to use the shared resource when necessary.

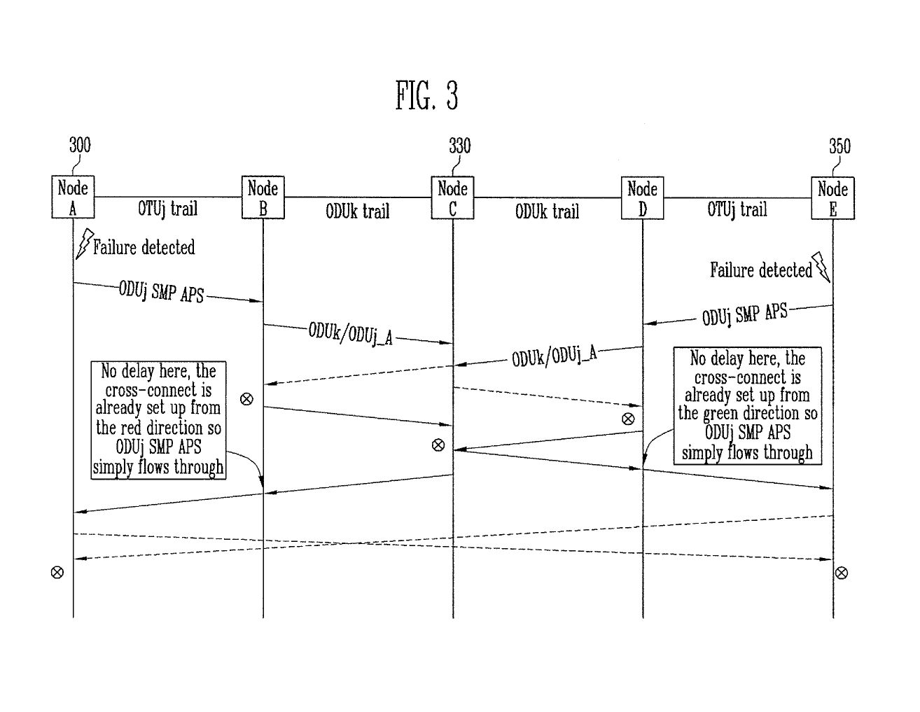

FIG. 3 illustrates a method for activating a bilateral ODU path.

FIG. 3 illustrates a method for activating a protection path corresponding to when an error occurs in a main path in an ODU SMP network where a resource availability notification method does not exist.

Referring to FIG. 3, when an error occurs in a main path (between node A 300 and node E 350), node A 300 and node E 350 may perform a procedure of activating a protection path. When an error is sensed in the main path, nodes of both ends (node A 300 and node E 350) may select a protection path set beforehand and initiate activating an ODUj connection. An ODUj connection activation may be performed as the nodes existing in a protection path set a cross connect and perform an additional ODUk/ODUj_A configuration when necessary. Since the ODUj connection activation is performed in both directions, node C 330 where the ODUj connection activation meets may use the connection made by the ODUj connection activation in another direction. Therefore, an additional ODUj activation procedure is not necessary. Using such a method, it is possible to save the ODU SMP time.

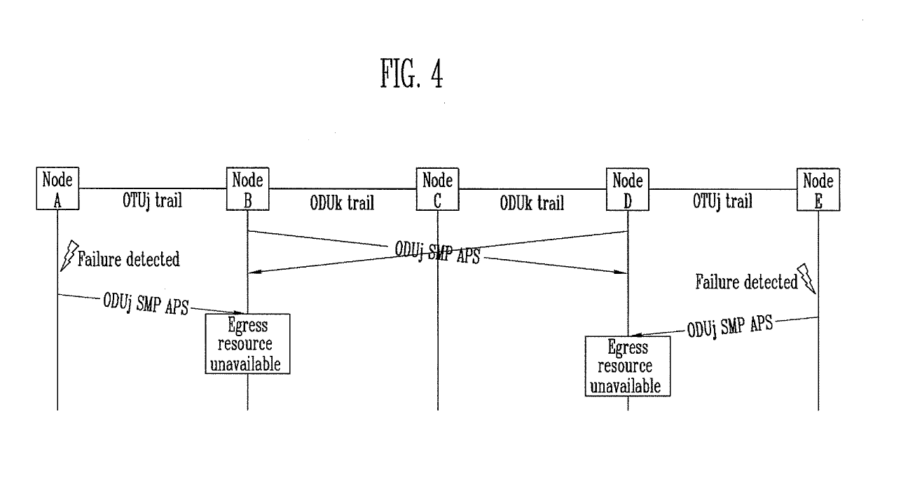

FIG. 4 is a conceptual view illustrating a failure of an ODU SMP.

Referring to FIG. 4, a path having a higher priority preoccupying and using a shared resource is the basic concept of an ODU SMP. Therefore, a protection path of a higher priority may preoccupy and use a resource that has been preoccupied and used by a protection path of a lower priority. That is, when a path having a higher priority fails to preoccupy a resource while a protection path having a lower priority attempts a protection switch, there may occur a problem of having to wait for a certain period of time.

If there does not exist a shared resource availability notification method, in the m:1 protection switching method, it may take a long time for a main path of m protection paths to search for a protection path suitable to a preoccupation standard to protect its traffic signal based on the entirety of the ODU SMP network.

A method for selecting a protection path in an ODU SMP network according to embodiments of the present invention is to resolve this problem. All the nodes that participate in m protection paths in m:1 or m:n protection switching may notify end nodes of the information on its shared resource availability. Based on this notification, it is possible to prevent the nodes of both ends from selecting a protection path of poor shared resource availability beforehand, thereby reducing the protection switching time. According to embodiments of the present invention, protocols may be defined to notify end nodes the availability of a shared resource by intermediate nodes located in the middle of a path to nodes from which an ODU path ends and starts. A shared resource availability notification method may be realized based on the ITU-T G.808.3. An OAMP function performed at an end node where an ODU path starts and end in an ODU SMP network may provide a user traffic signal using a protection path prepared beforehand when an error occurs while monitoring the status of a main path.

On the other hand, the intermediate nodes located in the middle of an ODU path may perform a function of notifying an end node of the shared resource status information while monitoring the status of a shared resource. Specially, the intermediate nodes may notify a head-end node and tail-end node of information on its shared resource availability. Using such a method, when an error occurs in a main path, end nodes may read a shared resource availability table and prevent beforehand protection paths where availability is not obtained from being selected of the plurality of protection paths that may be selected at end nodes, thereby reducing the protection switching time.

Currently, standardization of an ODU SMP is under process by two separate stages: 1-stage and 2-stage. A shared resource availability notification method according to an embodiment of the present invention may be performed based on a 2-stage protocol. The 2-stage ODU SMP protocol method is a technology from which an ODUk/ODUj_A (ODU multiplexing function) configuration function has been separated from an APS (automatic protection switching channel) SMP (shared mesh protection) signal when necessary.

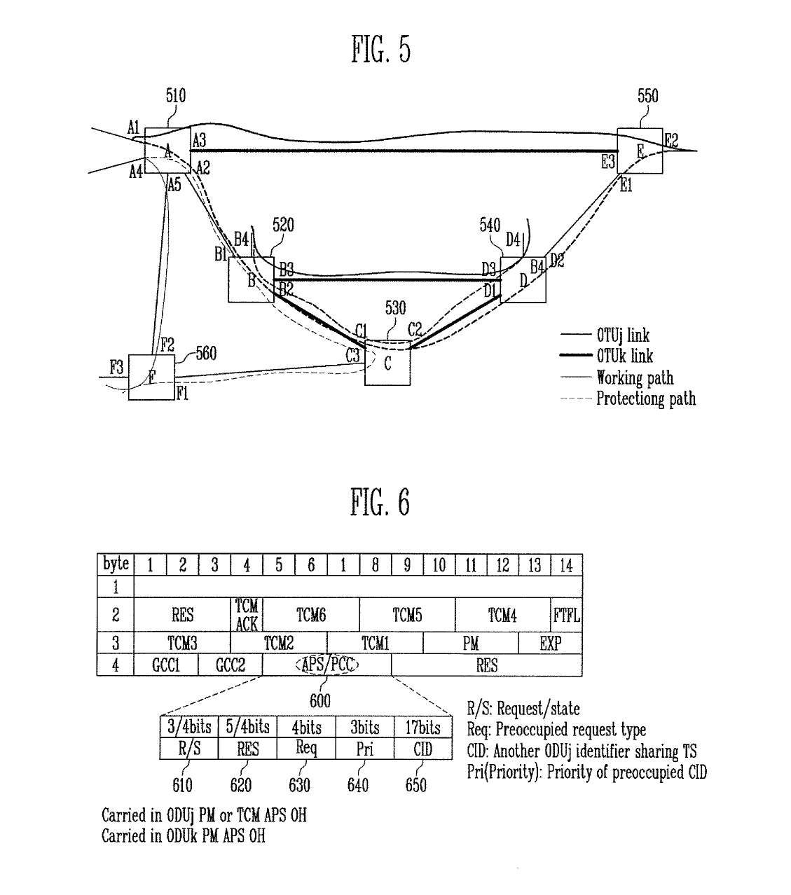

FIG. 5 is a conceptual view illustrating an ODU SMP network according to an embodiment of the present invention.

Referring to FIG. 5, node B 520, node C 530, and node D 540 support an ODUk and OTUj, and as in the example, a first protection path (a protection path connecting node A 510, node C 530, and node E 550), a second protection path (a protection path connecting node A 510, node F 560, and node C 530), and a third protection path (protection path connecting node B 520, node C 530, and node D 540) may preoccupy and use a shared resource of link B-C only when necessary. Link B-C and link C-D may provide only a link connection function of transmitting an ODUk signal or provide an ODUk trail function of servicing a low hierarchy ODUj depending on preoccupation of a protection path.

Properties (connection identifier, TCP (termination connection point), and connectivity status (Egress)), TSPN (Tributary Slot Port Number) and priorities are local mediating variables necessary for realizing a shared resource availability notification method based on a 2-stage ODU SMP protocol.

The connection identifier may be the only identifier that distinguishes a connection in an SMP domain. The TCP (Termination Connection Point) is a property that represents whether a node to which an ODU signal is inserted is in the middle or end of its connection. The connectivity status (Egress) represents a status of connection to a withdrawing port. The TSPN (Tributary Slot Port Number) represents an ODU_CP (Connection Point, Tributary Slot Port Number) used in a low hierarchy ODUj when a port from which an ODU signal is withdrawn is used as an ODUk server. The priority is an order of priority granted to connection identifiers.

And all the nodes participating in an ODU path need not have a same priority.

In each node, profile information may be defined based on the aforementioned properties. Table 1 below shows the profile information set in node B 520.

TABLE 1

| ODU_CP | ID | End/Inter | Destination | CS | Priority | TSPN |
|---|---|---|---|---|---|---|
| B1 | Green | Inter | B2 | ON | 1 | 1-8 |
| B1 | Red | Inter | B2 | ON | 2 | 9-16 |
| B2 | Red | Inter | B1 | OFF | 1 | 1-8 |
| B2 | Blue | Inter | B4 | ON | 3 | 17-24 |
| B2 | Green | Inter | B1 | ON | 2 | 17-24 |
| B3 | Red | End | B4 | ON | 2 | 9-16 |
| B4 | Red | End | B2 | OFF | 7 | 9-16 |
| B4 | Purple | Inter | B3 | ON | 4 | 17-24 |

Referring to table 1, for each node, a profile related to connection point information, identifier information, destination information, connection status information, priority information, TSPN information may be defined.

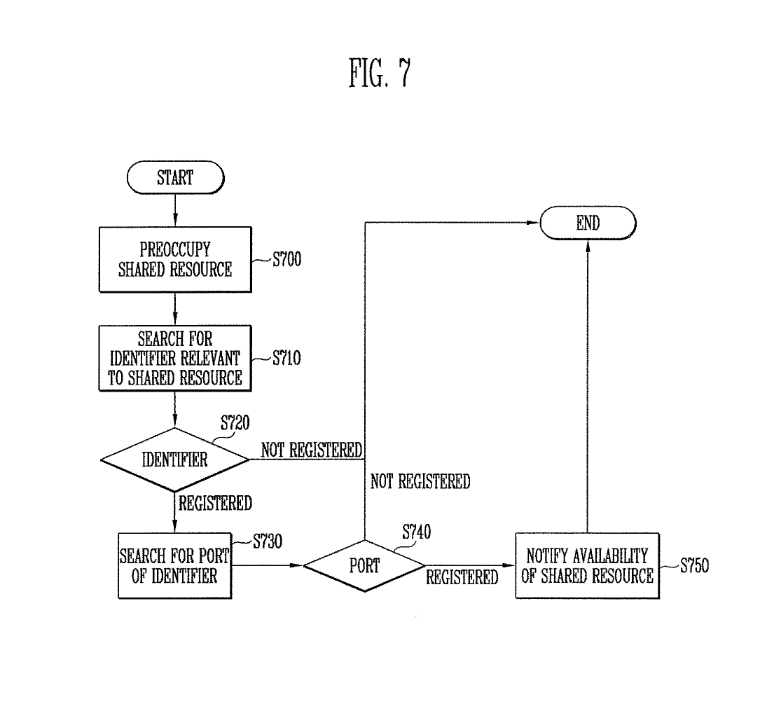

FIG. 6 is a conceptual view illustrating an ODU OH (overhead) according to an embodiment of the present invention.

In FIG. 6, an APS/PCC field 600 of an ODU header is modified so that intermediate nodes located in a protection path may transmit availability information on its shared resource to nodes of both end in real time. An intermediate node may be expressed as a protection path selection apparatus in other words.

The current OTN standard has been standardized to version 3, and the maximum capacity supported by one OTN interface is 100G. An ODU SMP according to an embodiment of the present invention may modify the APS/PCC field 600 of an ODU head and use it. A switch type used in the APS/PCC channel that the ITU-T G.873.1 defines is fixed in the ODU SMP, and thus modifying the APS/PCC field 600 may be possible.

That is because the switch type consists of a mode where an auto protection switch is performed, a bilateral switch function is provided, and a revert mode where a switch from a protection path to a main path is automatically performed. The changed APS/PCC field 600 may be divided into 4 subordinate fields as below.

An R/S (Request/State) 610 instructs a resource availability notification message (10100, Used by Higher Priority). Req 630 instructs a Request format of preoccupying a certain tributary slot. A pri (priority) 640 instructs a priority given to a certain ODU connection preoccupied by a shared resource. A CID (Connection Identifier) 650 instructs an ODU connection identifier relevant to a preoccupied shared resource.

Table 2 below shows the R/S field 610.

TABLE 2

| Field | Value | Description | Priority |
|---|---|---|---|
| Request/ State | 11110 11100 11010 11000 10110 10100 10000 01110 01100 01000 00100 00010 00001 00000 Others | Lockout for protection path (LO #i) Lockout of protection segment Lockout for normal traffic signal #i Signal Fail - Protection (SF-P) Forced Switch (FS #i) Used by Higher Priority (UH) Signal Fail - Working (SF - W) Used by Lower Priority (UL) Signal Degrade (SD) Manual Switch (MS #i) Wait-to-Restore (WTR) Exercise (EXER) Reverse Request (RR) No Request (NR) Reserved for future international standardization | 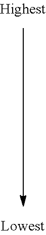 |

Protection paths may define preoccupation rules in the following order so as to preoccupy a shared resource. First of all, a priority may follow a priority allocated to each ODUj connection identifier. Next, when a priority is the same, the priority may follow a priority of commands for performing an APS based on an R/S (Request/State) field 610. Lastly, when the above two conditions (priority 640, R/S field 610) are the same, a service may be provided to an ODUj connection that attempted preoccupation first based on a FCFS (First Come First Service).

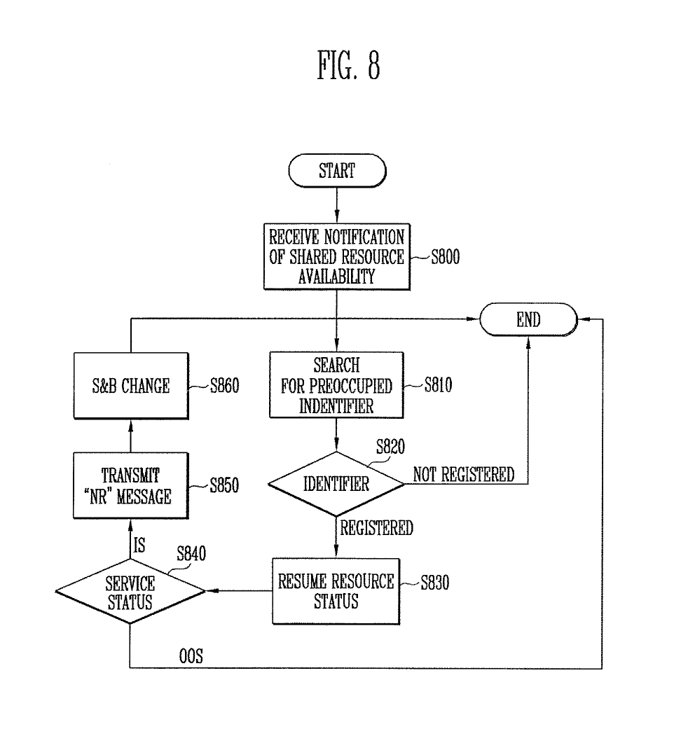

FIG. 7 is a flowchart illustrating an operation of an intermediate node according to an embodiment of the present invention.

FIG. 7 illustrates a procedure of generating a shared resource availability notification message in an intermediate node.

Referring to FIG. 7, when a shared resource managed in an intermediate node is preoccupied by a certain protection path (step S700), an identifier relevant to a shared resource may be searched (step S710).

Whether or not an identifier is registered in an intermediate node may be determined (step S720).

When an intermediate node is registered, a port of an identifier may be searched (step S730).

When an identifier is not registered in an intermediate node, it may be determined that an available resource is not available and the procedure may be ended.

When a port of an identifier is searched, whether or not a port is registered is determined (step S740).

When a port is registered, a shared resource availability may be notified (step S750).

When a port is not registered, it may be determined that a shared resource is not available and the procedure may be ended.

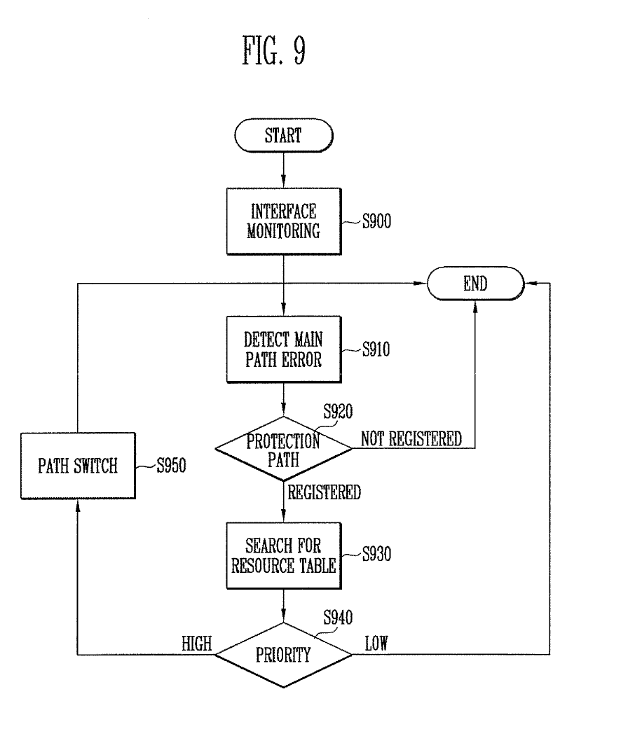

FIG. 8 is a flowchart illustrating a procedure of processing a shared resource availability notification message according to an embodiment of the present invention.

FIG. 8 illustrates a procedure in the case where nodes of both ends are notified from an intermediate node that a shared resource is available.

Referring to FIG. 8, the nodes of both ends may receive a shared resource availability notification message from the intermediate node (step S800).

A shared resource table of itself may be searched based on a CID (connection identifier) field identifier received from the intermediate node (step S810).

Whether or not a CID field identifier received from the shared resource table exists may be determined (step S820).

When there does not exist a CID field identifier received from the shared resource table, it is possible to end a shared resource availability notification message processing procedure.

When there exists a CID field in the shared resource table received from the intermediate node, information on the CID field is resumed (step S830).

A service status is determined (S840).

When the service status is OSS (out of service), a procedure may be ended. When the service status is IS (in-service), an NR (no request) message may be transmitted (step S850).

After an NR message is transmitted, an S&B may be changed (step S860).

If a resource corresponding to a CID being provided to a received shared resource availability notification message is used in a protection path of a low priority, a shared resource release may be notified to a neighboring node connected to an ODUj identifier having a low priority using an R/S (Request/state) field and then its cross connect may be released. Herein, ODUk/ODUj_A configuration information already configured may not be released. Because, if the ODU multiplex structure configured in advance is the same as a multiplex structure to be newly configured, it may be used without changing the ODU multiplexing.

FIG. 9 is a flowchart illustrating a procedure of a process of procedure according to an embodiment of the present invention.

FIG. 9 illustrates a procedure of selecting a protection path in the case where an error occurred in a main path.

FIG. 9 illustrates a procedure of selecting a protection path when an error occurs in a main path. FIG. 9 illustrates a procedure of selecting a shared protection path by a priority lower than itself after confirming a priority selected of candidate protection paths.

Referring to FIG. 9, an interface is monitored (step S900), and an error occurred in the main path is detected (step S910).

Whether or not an effective protection path exists in nodes of both ends is determined (step s920).

When a protection path is not registered, the protection path selection processing procedure is ended.

When a protection path is registered, a resource table is searched (step S930), a priority of the selected path may be determined (step S940).

When the priority of the selected protection path is high, a path switch is performed (step S950), and when the priority of the selected protection path is low, the protection path selection procedure is ended.

According to an embodiment of the present invention, an ODUj automatic protection switch may be performed using a protection path. The shared resource availability notification information (APS/PCC channel) defined above is carried using a TCM ODUj OH until a node where an ODUk/ODUj_A function is performed, and since a connection to the ODUj does not exist in an intermediate node, the shared resource notification information (APS/PCC channel) may be carried using the APS/PCC channel that exists in the ODUk OH since there does not exist a connection to the ODUj.

In the drawings and specification, there have been disclosed typical embodiments of the invention, and although specific terms are employed, they are used in a generic and descriptive sense only and not for purposes of limitation. As for the scope of the invention, it is to be set forth in the following claims. Therefore, it will be understood by those of ordinary skill in the art that various changes in form and details may be made therein without departing from the spirit and scope of the present invention as defined by the following claims.

What is claimed is:

1. A method for selecting a protection path in an ODU SMP (optical channel data unit shared mesh protection) network, the method comprising:
in response to a shared resource managed by an intermediate node being preoccupied by a certain protection path, searching by the intermediate node for an identifier relevant to the shared resource;
determining by the intermediate node whether or not the searched identifier is registered;
in response to determining that the identifier is registered, searching by the intermediate node for a port corresponding to the identifier; and
in response to the port being registered, transmitting by the intermediate node a shared resource availability message to a node corresponding to the port.

2. The method according to claim 1,
wherein the shared resource is allocated to a protection path based on a priority determined by applying a default priority, R/S (Request/State) field, and FCFS (First Come First Service), sequentially,
the default priority instructs a priority allocated to each ODUj connection identifier,
in response to a priority determined based on the default priority being the same, the R/S field instructs a command priority for performing an APS (auto protection switch), and
in response to a priority determined based on the default priority and the R/S field being the same, the FCFS is a priority providing preferential service to an ODUj connection that attempted preoccupation first.

3. The method according to claim 1,
further comprising:
searching by the node for a shared resource table based on a CID (connection identifier) field identifier included in the shared resource availability message;
in response to the CID field identifier existing in the shared resource table, updating by the node CID field information included in the shared resource table; and
in response to a resource corresponding to the CID field information being used in another protection path having a lower priority, notifying a neighboring node connected to an ODUj identifier having a lower priority based on the R/S field included in the shared resource availability message of a resource release, and releasing a cross connect.

4. The method according to claim 1,
further comprising:
monitoring by the intermediate node an interface and detecting an error that occurred in a main path;
determining by the intermediate node whether or not a protection path is registered in a node that generated the error;
in response to determining that a protection path registered, searching for a resource table and determining a priority ante protection path; and
performing a path switch based on the priority.

5. The method according to claim 1,
wherein the shared resource availability message includes an APS (auto protection switch)/PCC (protection communication channel) field,
the APS/PCC field includes an R/S (request/state) field, Req field, Pri field and CID (connection identifier) field,
the R/S field instructs a resource availability notification message,
the Req field instructs a request format preoccupying a certain shared resource (tributary slot),
the Pri field instructs a priority given to a certain ODU connection preoccupying a shared resource, and
the CID (connection identifier) instructs an ODU connection identifier relevant to the preoccupied shared resource.

6. An apparatus for selecting a protection path in an ODU SMP (optical channel data unit shared mesh protection) network,
wherein the apparatus for selecting a protection path is included in the ODU SMP network, and
the apparatus for selecting a protection path is configured to, in response to a shared resource that it manages being preoccupied by a certain protection path, search for an identifier relevant to the shared resource, determine whether or not the searched identifier is registered, and in response to determining that the identifier is registered, search for a port corresponding to the identifier, and in response to the port being registered, transmit a shared resource availability message to a node corresponding to the port.

7. The apparatus according to claim 6,
wherein the shared resource is allocated to a protection path based on a priority determined by applying a default priority, R/S (Request/State) field, and FCFS (First Come First Service), sequentially,
the default priority instructs a priority allocated to each ODUj connection identifier,
in response to a priority determined based on the default priority being the same, the R/S field instructs a command priority for performing an APS (auto protection switch), and
in response to a priority determined based on the default priority and the R/S field being the same, the FCFS is a priority providing preferential service to an ODUj connection that attempted preoccupation first.

8. The apparatus according to claim 6,
wherein the node is configured to search for a shared resource table based on a CID (connection identifier) field identifier included in the shared resource availability message, and in response to the CID field identifier existing in the shared resource table, update CID field information included in the shared resource table, and in response to a resource corresponding to the CID field information being used in another protection path having a lower priority, notify a neighboring node connected to an ODUj identifier having a lower priority based on the R/S field included in the shared resource availability message of a resource release, and release a cross connect.

9. The apparatus according to claim 6,
wherein the apparatus for selecting a protection path is configured to monitor an interface and detect an error that occurred in a main path, determine whether or not a protection path is registered in a node that generated the error, and in response to determining that the protection path is registered, search for a resource table and determine a priority of the protection path, and perform a path switch based on the priority.

10. The apparatus according to claim 6,
wherein the shared resource availability message includes an APS (auto protection switch)/PCC (protection communication channel) field,
the APS/PCC field includes an R/S (request/state) field, Req field, Pri field and CID (connection identifier) field,
the R/S field instructs a resource availability notification message,
the Req field instructs a request format preoccupying a certain shared resource (tributary slot),
the Pri field instructs a priority given to a certain ODU connection preoccupying a shared resource, and
the CID (connection identifier) instructs an ODU connection identifier relevant to the preoccupied shared resource.
